(19) United States
(12) Patent Application Publication
(10) Pub. No.: US 2021/0142349 A1
(43) Pub. Date: May 13, 2021

(54) STORAGE METHOD OF SECONDARY BATTERY, STORAGE SYSTEM OF SECONDARY BATTERY AND RECORDING MEDIUM

(71) Applicant: HONDA MOTOR CO., LTD., Tokyo (JP)

(72) Inventor: Takeshi Muro, Wako-shi (JP)

(21) Appl. No.: 17/080,869

(22) Filed: Oct. 27, 2020

(30) Foreign Application Priority Data
Nov. 7, 2019 (JP) 2019-202600

(51) Int. Cl. G06Q 30/02; G06Q 30/04; H01M 10/44

(52) U.S. Cl. CPC G06Q 30/0207; H01M 2220/20; H01M 10/44; G06Q 30/04

(57) ABSTRACT

A storage method of a secondary battery that will be mounted or that is mounted on an electrically driven vehicle at before of a delivery to a user is provided, and the storage method includes performing a supply and demand adjustment of an electric power system by using the secondary battery during a storage of the secondary battery at before of the delivery to the user, and billing the user a payment by discounting an extent of a decrease in performance of the secondary battery caused by the supply and demand adjustment from a price of the electrically driven vehicle.

### CROSS-REFERENCE TO RELATED APPLICATION

Priority is claimed on Japanese Patent Application No. 2019-202600, filed Nov. 7, 2019, the content of which is incorporated herein by reference.

### BACKGROUND OF THE INVENTION

### Field of the Invention

The present invention relates to a storage method of a secondary battery, a storage system of a secondary battery, and a recording medium.

### Description of Related Art

In a system of renting a secondary battery for an electrically driven vehicle, a system that manages charging/discharge of a battery and tries to consider the efficiency of the secondary battery in preparation for rental is known (for example, see Japanese Unexamined Patent Application, First Publication No. 2002-216855, Japanese Unexamined Patent Application, First Publication No. 2002-251456, Japanese Unexamined Patent Application, First Publication No. 2010-146473, Japanese Unexamined Patent Application, First Publication No. 2001-023037).

### SUMMARY OF THE INVENTION

However, in the related art, in a situation in which an electrically driven vehicle or a secondary battery before being delivered to a user is stored in a warehouse or the like, storage considering the efficiency of the secondary battery has not been sufficiently examined.

An aspect of the present invention is directed to providing a storage method of a secondary battery, a storage system of a secondary battery, and a recording medium that are capable of storing an electrically driven vehicle or a secondary battery before delivery to a user in consideration of the efficiency of the secondary battery.

A storage method of a secondary battery, a storage system of a secondary battery and a recording medium according to the present invention employ the following configurations.

(1) A storage method of a secondary battery which will be mounted or which is mounted on an electrically driven vehicle at before of a delivery to a user according to an aspect of the present invention includes: performing a supply and demand adjustment of an electric power system by using the secondary battery during a storage of the secondary battery at before of the delivery to the user; and billing the user a payment by discounting an extent of a decrease in performance of the secondary battery caused by the supply and demand adjustment from a price of the electrically driven vehicle.

(2) In the aspect of the above-mentioned (1), when the supply and demand adjustment is performed, the supply and demand adjustment using the secondary battery may be performed within a range in which an extent of a decrease in performance of the secondary battery caused by the supply and demand adjustment falls in a range allowed by the user.

(3) In the aspect of the above-mentioned (2), when the supply and demand adjustment is performed, the range in which the extent of the decrease in performance of the secondary battery caused by the supply and demand adjustment falls in the range allowed by the user is determined on the basis of a charging amount of the electrically driven vehicle.

(4) In the aspect of any one of the above-mentioned (1) to (3), the discount from the price may be derived on the basis of a use aspect of the secondary battery during the storage.

(5) A storage system of a secondary battery according to an aspect of the present invention, which will be mounted or which is mounted on an electrically driven vehicle at before of a delivery to a user, the storage system including: a supply and demand adjustment part configured to perform a supply and demand adjustment of an electric power system by using the secondary battery during a storage of the secondary battery at before of the delivery to the user; and a billing management part configured to bill the user a payment by discounting an extent of a decrease in performance of the secondary battery caused by the supply and demand adjustment from a price of the electrically driven vehicle.

(6) A recording medium according to an aspect of the present invention, in which a program is stored to cause a computer to perform a supply and demand adjustment of an electric power system by using a secondary battery that will be mounted or that is mounted on an electrically driven vehicle during a storage of the secondary battery at before of the delivery to a user; and bill the user a payment by discounting an extent of a decrease in performance of the secondary battery caused by the supply and demand adjustment from a price of the electrically driven vehicle.

According to the aspects of the above-mentioned (1) to (6), an electrically driven vehicle or a secondary battery at before of a delivery to a user can be stored in consideration of an efficiency of the secondary battery.

### BRIEF DESCRIPTION OF THE DRAWINGS

FIG. 1 is a view showing an example of a configuration and a usage environment of a V2G system including a management device according to an embodiment.

FIG. 2 is a block diagram showing an example of the configuration of the management device.

FIG. 3 is a view showing an example of details of storage conditions information.

FIG. 4 is a view showing an example of details of vehicle-related information.

FIG. 5 is a view showing an example of power demand prediction.

FIG. 6 is a view showing an example of details of charge/discharge history information.

FIG. 7 is a view showing an example of details of price-related information.

FIG. 8 is a flowchart showing an example of supply and demand adjustment.

FIG. 9 is a flowchart showing an example of supply and demand adjustment.

FIG. 10 is a flowchart showing an example of billing management.

### DETAILED DESCRIPTION OF THE INVENTION

### First Embodiment

Hereinafter, embodiments of a storage method of a secondary battery, a storage system of a secondary battery, and a recording medium on which a program is stored will be described with reference to the accompanying drawings. In the following description, an in-vehicle battery that is a storage object may be a battery when mounted in an electrically driven vehicle or may be a battery when not mounted in an electrically driven vehicle (having been removed and stored). It is presumed that the electrically driven vehicle is an electric automobile in which a secondary battery is mounted, the electrically driven vehicle may be a vehicle in which electric power from the outside is able to be stored, and may be a vehicle in which a secondary battery configured to supply electric power for driving is mounted, such as a hybrid automobile or a fuel cell vehicle. The electrically driven vehicle may be a plug-in hybrid car.

### [Summary of V2G System]

First, a summary of a vehicle to grid (V2G) system will be described. The V2G system is a system configured to perform exchange of electric power between an electric power system including a commercial power network and an in-vehicle battery. The exchange of electric power includes both of power supply from the electric power system to the in-vehicle battery and power supply from the in-vehicle battery to the electric power system. In the V2G system, generally, an in-vehicle battery of an electrically driven vehicle after it is delivered to a user is used as electric power storage equipment, and bidirectional delivery of electric power is performed between the electrically driven vehicle and the electric power system that are participating in the V2G system. Hereinafter, the case in which subjects of the V2G system are extended to an electrically driven vehicle or an in-vehicle battery at before of a delivery and the in-vehicle battery at before of a delivery is used as electric power storage equipment during storage in a warehouse or the like will be described.

### [Entire Configuration]

FIG. 1 is a view showing an example of a configuration and a usage environment of a V2G system 1 including a storage system according to an embodiment. As shown in FIG. 1, the V2G system 1 includes an electric power supplier 100, a plurality of external power supply devices 200 (200-1, 200-2, 200-3, 200-4, . . . ), an electrically driven vehicle 300 in which an in-vehicle battery 310 is mounted, a management device 400, and a terminal device 500. Further, in the following description, when one of the external power supply devices 200-1, 200-2, 200-3, 200-4, . . . is not specified, external power supply devices 200 are referred to. Further, in FIG. 1, while one electrically driven vehicle 300 is shown, there may be plural electrically driven vehicles 300. In addition, a plurality of electrically driven vehicles 300 or a plurality of vehicle batteries 310 may be connected to the external power supply devices 200.

First, an example of a usage environment of the V2G system 1 will be described. The external power supply devices 200 are installed in, for example, a storage facility 260 in which a plurality of vehicles can be stored. For example, the external power supply device 200 relays delivery of electric power between the electric power system and the in-vehicle battery 310.

For example, a manager parks the electrically driven vehicle 300 in the storage facility 260, and then, connects the electrically driven vehicle 300 to the external power supply device 200. The management device 400 manages whether delivery of electric power between the electric power supplier 100 and the electrically driven vehicle 300 via the external power supply device 200 is performed. For example, when use of the in-vehicle battery 310 during storage is allowed by a user of the electrically driven vehicle 300 through a contract, the management device 400 performs delivery of electric power. Then, the management device 400 performs control such that electric power is supplied to the electrically driven vehicle 300 and electric power is received from the electrically driven vehicle 300 via the external power supply device 200. That is, in other words, the management device 400 is a device configured to support use of the in-vehicle battery 310 during storage on the basis of a contract of the user. The management device 400 performs control such that electric power can be shared between the electric power system including a commercial power network and the electrically driven vehicle 300. The sharing of electric power includes the supply of power supply from the electric power system to the electrically driven vehicle 300 and the supply of power from the electrically driven vehicle 300 to the electric power system.

The electric power supplier 100 and the external power supply device 200 are connected via a power transmission line 240. The external power supply device 200 and the electrically driven vehicle 300 are connected via a cable 220. Further, the cable 220 is a power feeding cable, which may include a signal line. In addition, in the cable 220, the signal line may be superimposed on the power feeding cable.

The management device 400 and the external power supply device 200 are connected via a network NW. The network NW includes, for example, the Internet, a wide area network (WAN), a local area network (LAN), a provider device, a radio base station, or the like. Further, the management device 400 may communicate with the electrically driven vehicle 300 via the network NW or directly. The management device 400 and the terminal device 500 are connected via the network NW.

[Electric Power Supplier 100]

The electric power supplier 100 includes a power station configured to generate power using energy such as thermal power, wind power, atomic power, solar light, or the like, and for example, supplies electric power to an assigned district. Further, the district disclosed herein may be defined in any manner, and the district may be defined as a unit of an administrative district such as an administrative division, a town, or the like, or may be defined as a unit of a jurisdiction of a substation. Further, an example shown in FIG. 1 is an example of one district, and the electric power supplier 100 is one example. For example, the electric power supplier 100 may transmit power demand prediction information showing a power demand prediction for each hour in a day in the district corresponding to the electric power supplier 100 to the management device 400 via the network NW. In addition, for example, the electric power supplier 100 transmits electric power generation prediction information, which indicates predicted electric power generation for each hour in a day for respective types of power generation, to the management device 400 via the network NW in the district corresponding to the electric power supplier 100. The electric power generation prediction includes a prediction value of electric power generation by thermal power generation, a prediction value of electric power generation by wind power generation, a prediction value of electric power generation by atomic power, a prediction value of electric power generation by solar light, and the like.

[External Power Supply Device 200]

The external power supply device 200 includes, for example, a housing 202, a control device 204, a communication part 206 and a cable connecting port 208.

Each of the plurality of external power supply devices 200-1, 200-1 . . . communicates with the management device 400 via the network NW. In addition, the external power supply device 200 is connected to the electric power supplier 100 via the power transmission line 240, and connected to the electrically driven vehicle 300 via the cable connecting port 208 and the cable 220.

The external power supply device 200 outputs a charge/discharge instruction received from the management device 400 via the network NW to the electrically driven vehicle 300 via the cable connecting port 208 and the cable 220. The charge/discharge instruction includes a charge instruction that instructs the electrically driven vehicle 300 to receive electric power from the electric power supplier 100, and a discharge instruction that instructs the electrically driven vehicle 300 to discharge electric power to the electric power supplier 100 from the secondary battery thereof. Detailed description of the charge/discharge instruction will be described below.

The external power supply device 200 acquires various types of information output from the electrically driven vehicle 300 via the cable 220 and the cable connecting port 208, and transmits the various types of information which has been acquired to the management device 400 via the network NW. The various types of vehicle information includes, for example, remaining fuel information (for example, SOC), a battery voltage value, a battery current value, and the like.

For example, during power storage by the secondary battery of the electrically driven vehicle 300, the external power supply device 200 supplies the electric power provided from the electric power supplier 100 via the power transmission line 240 to the electrically driven vehicle 300 via the cable 220. Meanwhile, upon discharge of the secondary battery of the electrically driven vehicle 300, the external power supply device 200 supplies the electric power provided from the electrically driven vehicle 300 via the cable 220 to the electric power supplier 100 via the power transmission line 240. Further, the external power supply device 200 includes a charge/discharge controller configured to control charging of and discharge from the electrically driven vehicle 300, and may directly instruct charge to and discharge from the electrically driven vehicle 300.

For example, the control device 204 and the communication part 206 may be built into the housing 202.

The control device 204 acquires various types of information output from the electrically driven vehicle 300 from the electrically driven vehicle 300 via the cable 220 and the cable connecting port 208. The control device 204 outputs the various types of information which has been acquired to the communication part 206 from the management device 400 that is a destination of transmission. The control device 204 outputs the charge/discharge instruction output from the communication part 206 to the electrically driven vehicle 300 via the cable 220 and the cable connecting port 208. The communication part 206 receives the charge/discharge instruction transmitted from the management device 400 via the network NW, and outputs the received charge/discharge instruction to the control device 204. The communication part 206 transmits the various types of information output from the control device 204 to the management device 400 via the network NW.

The cable connecting port 208 is formed to open in an outer surface of the housing 202. The cable 220 is able to be connected to the cable connecting port 208.

The cable 220 includes a first plug 222 and a second plug 224. The first plug 222 is connected to the cable connecting port 208 of the external power supply device 200, and the second plug 224 is connected to a connector 360 of the electrically driven vehicle 300.

### [Electrically Driven Vehicle 300]

The electrically driven vehicle 300 includes, for example, the in-vehicle battery 310 (the secondary battery), a battery sensor 320, a temperature sensor 330, a vehicle controller 340, a vehicle memory 350, and the connector 360. Further, the electrically driven vehicle 300 also includes an inverter, a motor, a transmission, wheels, and the like, which are not shown.

The in-vehicle battery 310 is a secondary battery such as a lithium ion battery or the like. The in-vehicle battery 310 stores electric power or discharges the stored electric power according to control of the vehicle controller 340.

The battery sensor 320 detects, for example, a current value and a voltage value of the in-vehicle battery 310, and outputs current values and voltage values that have been detected to the vehicle controller 340.

The temperature sensor 330 detects, for example, an ambient temperature of the in-vehicle battery 310, and outputs ambient temperature information showing the detected ambient temperature to the vehicle controller 340.

The vehicle controller 340 derives a charging amount of the in-vehicle battery 310 on the basis of the current value and the voltage value of the in-vehicle battery 310 output from the battery sensor 320. The charging amount of the in-vehicle battery 310 is a state of charge (SOC; a charge rate) of the in-vehicle battery 310. For example, the vehicle controller 340 derives the SOC of the in-vehicle battery 310, for example, at predetermined time intervals using, for example, a current integrating method or an open circuit voltage (OCV) estimation method.

The vehicle controller 340 controls charge to and discharge from the in-vehicle battery 310 on the basis of the charge/discharge instruction output from the external power supply device 200 and the derived SOC. The vehicle controller 340 reads a vehicle ID recorded in the vehicle memory 350. The vehicle ID is identification information that identifies the electrically driven vehicle 300.

The vehicle controller 340 associates the vehicle ID with the above-mentioned remaining fuel information, the ambient temperature information, and the like, and outputs the associated vehicle ID to the external power supply device 200 via the connector 360 and the cable 220. Further, the vehicle controller 340 may output the various types of information to the external power supply device 200 when a predetermined instruction is acquired from the external power supply device 200 or the management device 400 via the connector 360 from the external power supply device 200.

The vehicle controller 340 supplies electric power to a motor that is a drive source of the electrically driven vehicle 300 and other devices (not shown) that require electricity when the electrically driven vehicle 300 is not connected to the external power supply device 200. Meanwhile, the vehicle controller 340 performs charge/discharge according to requirements from the management device 400 when the electrically driven vehicle 300 is connected to the external power supply device 200.

The vehicle memory 350 stores the vehicle ID, the remaining fuel information, the ambient temperature information, and the like.

The connector 360 is connected to the second plug 224 of the cable 220.

### [Terminal Device 500]

The terminal device 500 is a terminal such as a cellular phone, a smartphone, a tablet phone, a laptop computer, a desktop computer, and the like, and communicates with the management device 400 via the network NW. For example, the terminal device 500 receives an operation instruction from a salesperson in a store or a user who purchases the electrically driven vehicle 300 (or only the in-vehicle battery), and transmits user setting information showing contract details to the management device 400. The user setting information includes various types of information set by a user or various types of information including contract details.

### [Management Device 400]

FIG. 2 is a block diagram showing an example of a configuration of the management device 400. The management device 400 includes, for example, a communication part 410, a supply and demand adjustment part 420, a billing management part 430, and a memory 450.

The communication part 410 communicates with the electric power supplier 100, the plurality of external power supply devices 200, and the terminal device 500 via the network NW. The communication part 410 communicates with the electrically driven vehicle 300 via the network NW and the external power supply device 200. The communication part 410 is not limited thereto and may directly communicate with the electrically driven vehicle 300 via the network NW.

The supply and demand adjustment part 420 and the billing management part 430 are realized by executing a program (software) using a hardware processor such as a central processing unit (CPU) or the like. Some or all of the components may be realized by hardware (a circuit part; including circuitry) such as a large scale integration (LSI), an application specific integrated circuit (ASIC), a field-programmable gate array (FPGA), a graphics processing unit (GPU), or the like, or may be realized by cooperation of software and hardware. The program may have been previously stored in a storage device (a non-transient recording medium) such as a hard disk drive (HDD), a flash memory, or the like, or may be stored in a detachable recording medium (non-transient recording medium) such as a DVD, a CD-ROM, or the like, and installed by mounting the recording medium in a drive device.

The supply and demand adjustment part 420 manages supply and demand adjustment of the electric power system using the in-vehicle battery 310. The billing management part 430 requests a user for a payment of a bill after discounting an extent of decrease in performance of the in-vehicle battery 310 caused by the supply and demand adjustment from a price of the electrically driven vehicle 300. For example, storage conditions information 451, vehicle-related information 452 and charge/discharge history information 453 are stored in the memory 450. Hereinafter, this will be described in detail.

The supply and demand adjustment part 420 includes, for example, an acquisition part 421, a determination part 422, a charge/discharge instruction part 423, and a recording part 424.

The acquisition part 421 acquires the user settings information including the contract details or the other settings from the terminal device 500 via the network NW. The acquisition part 421 stores the acquired user setting information in the memory 450 as a part of the storage conditions information 451.

The storage conditions information 451 includes information showing a storage conditions of the electrically driven vehicle 300. FIG. 3 is a view showing an example of details of the storage conditions information 451. For example, the storage conditions information 451 is information in which a start date, an end date, existence of cooperation, restriction conditions, a discharge limit value, a charge limit value, and a cooperation level are associated with a vehicle ID.

The start date and the end date are a starting point and an ending point of a storage period determined by a contract, respectively. The start date is, for example, a date of delivery to the storage facility 260, and the end date is, for example, a date of delivery to a user's home or the like. The existence of cooperation is information showing whether there is a will for cooperation with the supply and demand adjustment, which have been previously determined by the contract. For example, when transfer of the electric power is permitted by the user in the storage period with the electric power supplier 100, a cooperative flag is registered.

The restriction condition is a condition in which use of the in-vehicle battery 310 in the storage period is restricted, and determined by the contract. The restriction conditions include, for example, a condition in which the in-vehicle battery 310 is not used for a specific purpose, a condition in which the in-vehicle battery 310 is not used under a specific environment, or the like.

The discharge limit value is a limit value when electric power is discharged upon the supply and demand adjustment, and the charge limit value is a limit value when electric power is charged upon the supply and demand adjustment. The discharge limit value and the charge limit value are previously determined by the contract according to specification of a use desired by a user in use of the in-vehicle battery 310 during storage. For example, when a user wants to use the in-vehicle battery 310 with emphasis on performance (wants to minimize deterioration of the in-vehicle battery 310), the discharge limit value and the charge limit value are values that are previously determined in view of performance of the in-vehicle battery 310, and for example, the discharge limit value is an SOC of 40% and the charge limit value is an SOC of 60%. Meanwhile, when a user wants to use the in-vehicle battery 310 with emphasis on a large discount through cooperation with the supply and demand adjustment during storage, in the discharge limit value and the charge limit value, for example, the discharge limit value may be an SOC of 0% and the charge limit value may be an SOC of 100%. Further, the discharge limit value may be an SOC that enables traveling to a delivery place such as a user's home or the like in preparation for traveling of the electrically driven vehicle 300 after departure from the storage facility 260.

The cooperation level is information showing a degree of cooperation with the supply and demand adjustment, which is previously determined by the contract. The cooperation level may be shown as a plurality of height levels, or may indicate whether the level is high or low. For example, the cooperation level is previously determined according to a charge/discharge time length, a charge/discharge electric power amount, a restriction condition, a discharge limit value, a charge limit value, and the like, which are allowed during storage. The cooperation level is higher as a larger amount of electric power is allowed to be transferred with the electric power supplier 100. In addition, when a specific requirement such as cooperation with the charge is satisfied during a high demand period including the peak of the electric power demand, the cooperation level may be considered higher in such case than in the other period. In addition, at the highest cooperation level, it may be determined to cooperate with the supply and demand adjustment even when the ambient temperature is high in a case of an emergency, cooperate with discharge until the charging amount becomes zero even when it exceeds a limit level in a case of a disaster, or the like. Meanwhile, in a case the restriction condition is determined by the contract, the cooperation level may be considered lower in such case than that in the other cases.

The acquisition part 421 acquires the various types of information from the electrically driven vehicle 300 via the network NW and the external power supply device 200. The various types of information includes, for example, the vehicle ID, a remaining fuel information (for example, the SOC), ambient temperature information, and the like. The acquisition part 421 stores the various types of information acquired in the memory 450 as a part of the vehicle-related information 452.

The vehicle-related information 452 includes information acquired from the electrically driven vehicle 300. FIG. 4 is a view showing an example of details of the vehicle-related information 452. The vehicle-related information 452 is, for example, information in which an SOC and an ambient temperature correspond to the vehicle ID. In this example, while the SOC and the ambient temperature are overwritten with the latest information, there is no limitation thereto and the entire information may be stored in the memory 450.

The acquisition part 421 acquires power demand prediction information or electric power generation prediction information from the electric power supplier 100 via the network NW, and stores the acquired information in the memory 450.

The determination part 422 determines a period in which discharge is required by the electrically driven vehicle 300 (a high demand period) from a viewpoint of the V2G system and a period in which charge is required by the electrically driven vehicle 300 (a low demand period) from a viewpoint of the V2G system. For example, the determination part 422 determines a period in which the power demand prediction exceeds a first threshold as the high demand period on the basis of the power demand prediction information acquired from the electric power supplier 100. In addition, the determination part 422 determines a period in which the power demand prediction is smaller than a second threshold (second threshold<first threshold) as the low demand period.

FIG. 5 is a view showing an example of the power demand prediction. A horizontal axis shows a time, and a vertical axis shows power consumption (kw). For example, the determination part 422 determines a period from 12:00 to 16:00 that exceeds the first threshold as a first high demand period HD1. In addition, the determination part 422 determines a period from 18:30 to 21:00 that exceeds the first threshold as a second high demand period HD2. In addition, the determination part 422 determines a period from 22:30 to 32:00 (AM 8:00) that is below a second threshold as a first low demand period LD1. The determination part 422 determines a period in which electric power generation by photovoltaic generation (PV) included in the power demand prediction information exceeds a predetermined value as a second low demand period LD2. Not limited to this, the determination part 422 may determine a high demand period and a low demand period expected from the past history on the basis of a month and a day, a season, weather forecast information acquired from an external server, or the like.

The determination part 422 sets a control condition for charge/discharge such that the supply and demand adjustment using the in-vehicle battery 310 is performed within a range in which a decrease degree in performance of the in-vehicle battery 310 caused by the supply and demand adjustment falls in a range allowed by a user. The control condition includes, for example, a charge/discharge period, a charge/discharge start timing, a charge/discharge end timing, and the like.

For example, the determination part 422 determines at least one of a discharge period and a charge period during storage. The determination part 422 determines the discharge period and the charge period on the basis of, for example, contract details. For example, when the cooperation level is high, both of the first high demand period HD1 and the second high demand period HD2 are determined as the discharge period, and the entire period of the first low demand period LD1 is determined as the charge period. When the cooperation level is low, either the first high demand period HD1 or the second high demand period HD2 is determined as the discharge period, and a part of the first low demand period LD1 is determined as the charge period.

For example, the determination part 422 determines at least one of the discharge end timing and the charge end timing. For example, the discharge end timing is defined as a time when the discharge is terminated or an SOC in which the discharge is terminated. For example, the charge end timing is defined as a time when the charge is terminated or an SOC in which the charge is terminated. For example, the determination part 422 may determine the discharge end timing or the charge end timing on the basis of the cooperation level. In a case the cooperation level is higher than the case the cooperation level is low, the discharge end timing is determined such that the discharge time length is increased and the discharge end timing is determined such that the SOC is decreased.

In addition, the determination part 422 may determine the charge/discharge period or the end timing such that charge/discharge is not executed during a period that coincides with the restriction condition when the restriction condition is set. For example, in the case in which restriction of the charge/discharge is set when the ambient temperature of the electrically driven vehicle 300 is a specific temperature ° C. or more, the determination part 422 may determine the end timing with the highest priority when the ambient temperature reaches the specific temperature ° C.

In addition, the determination part 422 may determine a range, in which a decrease degree in performance of the in-vehicle battery 310 caused by the supply and demand adjustment falls in a range allowed by a user, on the basis of the charging amount of the in-vehicle battery 310. For example, the determination part 422 may determine a time when the SOC of the in-vehicle battery 310 reaches the discharge limit value as the discharge end timing, and may determine a time when the SOC of the in-vehicle battery 310 reaches the charge limit value as the charge end timing.

The charge/discharge instruction part 423 instructs discharge from the electrically driven vehicle 300 in order to provide electric power to the electric power supplier 100. For example, the charge/discharge instruction part 423 may instruct to start the discharge from the start time of the high demand period, or may instruct start the discharge from the start time of the discharge period determined by the determination part 422. In addition, the charge/discharge instruction part 423 instructs the charge to the electrically driven vehicle 300 in order to charge the electric power from the electric power supplier 100. The charge/discharge instruction part 423 may instruct to start the charge from the start time of the low demand period, or may instruct to start the discharge from the start time of the discharge period determined by the determination part 422.

The recording part 424 stores the various types of information related to the charge/discharge in the memory 450 as a part of the charge/discharge history information 453. The recording part 424 derives the actual charge/discharge period, the charge/discharge time length, the discharge electric power amount, the charge electric power amount, and the like, on the basis of the instruction by the charge/discharge instruction part 423, and writes them in the charge/discharge history information 453. In addition, the recording part 424 may determine the actual cooperation level on the basis of the actual charge/discharge situation, and may write it in the charge/discharge history information 453.

FIG. 6 is a view showing an example of details of the charge/discharge history information 453. The charge/discharge history information 453 is, for example, information in which the charge/discharge period, the charge/discharge time length, the discharge electric power amount, the charge electric power amount, and the actual cooperation level are associated with the vehicle ID. The charge/discharge period includes a date and a time when the actual discharge (or charge) is started or a date and a time when terminated. The charge/discharge time length is a time length in which the discharge (or the charge) is actually performed. The discharge electric power amount and the charge electric power amount are electric power amounts discharged or charged in the corresponding charge/discharge period. The actual cooperation level includes a situation a degree of the cooperation, or the like when cooperation with the supply and demand adjustment is performed. The actual cooperation level includes, for example, charge/discharge under an environment in which an ambient temperature is a specific temperature ° C. or more, a third time charge/discharge in a day, continuous charge/discharge for specific hours or more, or the like.

Returning to FIG. 2, the billing management part 430 includes, for example, a price acquisition part 431, a discount amount deriving part 432, and a billing part 433.

The price acquisition part 431 acquires price information including a price at the time of sale of the electrically driven vehicle 300 from the terminal device 500 via the network NW. The price acquisition part 431 stores the acquired price information in the memory 450 as a part of price-related information 454.

FIG. 7 is a view showing an example of details of the price-related information 454. The price-related information 454 is, for example, information in which a first price (an expected sales price), a discount amount, and a second price (a billing price) correspond to the vehicle ID. The first price (the expected sales price) is a price of the electrically driven vehicle 300 at the time it was sold. The discount amount is obtained in price by reflecting an extent of a decrease in performance of the in-vehicle battery 310 caused by the supply and demand adjustment. The second price (the billing price) is a price obtained by subtracting the discount amount from the expected sales price.

The discount amount deriving part 432 derives the discount amount according to the cooperation situation with the supply and demand adjustment (i.e., a use aspect of the in-vehicle battery 310). For example, the discount amount deriving part 432 derives a plurality of addition parameters with reference to the charge/discharge history information 453, and derives a discount amount by summing the derived addition parameters. As a result, the discount amount can be derived on the basis of the actually cooperated charge/discharge situation. Further, which addition parameter is included is included in the discount amount among the plurality of addition parameters may be arbitrarily set, and may be determined according to a vehicle type, an used age, a deterioration degree of the in-vehicle battery 310, or the like of the electrically driven vehicle 300. In addition, the discount amount may be derived by weighting according to which addition parameter is emphasized. For example, the discount amount deriving part 432 may derive the discount amount on the basis of the contracted cooperation details, and detailed description thereof is as follows.

The billing part 433 derives a billing price to a user with reference to the price-related information 454, and charges the user a billing price. For example, the billing part 433 subtracts the discount amount from the expected sales price and derives the billing price. That is, when the discount is 0 Yen with no cooperation with respect to the supply and demand adjustment, the billing part 433 charges the user the expected sales price. Meanwhile, when the discount is larger than 0 Yen with cooperation with respect to the supply and demand adjustment, the billing part 433 charges the user the billing price obtained by subtracting the discount amount from the expected sales price. The billing part 433 may issue the bill and directly charge the user the bill via the Internet (or by mail), or may charge the billing price to a credit card company or other company that manages cashless trade.

### [Regarding the Supply and Demand Adjustment]

FIGS. 8 and 9 are flowcharts showing an example of the supply and demand adjustment. The supply and demand adjustment part 420 executes the following flow for each electrically driven vehicle 300. First, the acquisition part 421 acquires user setting information from the terminal device 500 via the network NW, and registers the user setting information in the memory 450 as a part of the storage conditions information 451 (step S101). Next, the acquisition part 421 acquires the various types of information from the electrically driven vehicle 300 via the network NW and the external power supply device 200, and registers the acquired information in the memory 450 as a part of the vehicle-related information 452 (step S103).

Next, the determination part 422 determines whether the discharge cooperation is performed (step S105). For example, when the discharge in the supply and demand adjustment is allowed by the contract with the user, the determination part 422 determines that the discharge cooperation can be performed.

When it is determined that the discharge cooperation can be performed, the determination part 422 determines the high demand period on the basis of the demand prediction information (step S107). Next, the determination part 422 determines the discharge period of the electrically driven vehicle 300 on the basis of the determined high demand period (step S109), and determines the discharge end timing on the basis of the cooperation level (step S111). Then, the charge/discharge instruction part 423 instructs the discharge to the electrically driven vehicle 300 such that the discharge is performed until the discharge end timing when the determined discharge period has come (step S113). In this processing, the charge/discharge instruction part 423 may directly control the discharge according to the details determined in real time, or may control the discharge on the side of the electrically driven vehicle 300 while instruction details are transmitted to the electrically driven vehicle 300.

Next, as shown in FIG. 9, the determination part 422 determines whether the charge cooperation is performed (step S115). For example, when the charge in the supply and demand adjustment is allowed by the contract with the user, the determination part 422 determines that the charge cooperation can be performed.

When it is determined that the charge cooperation is performed, the determination part 422 determines the low demand period on the basis of the demand prediction information (step S117). Next, the determination part 422 determines the charge period of the electrically driven vehicle 300 on the basis of the determined low demand period (step S119), and determines the charge end timing on the basis of the cooperation level (step S121). Then, the charge/discharge instruction part 423 instructs the charging with respect to the electrically driven vehicle 300 such that the charge is performed until the charge end timing when the determined charge period has come (step S123). In this processing, the charge/discharge instruction part 423 may directly control the charge according to the details determined in real time, and may control the charge on the side of the electrically driven vehicle 300 while the instruction details are transmitted to the electrically driven vehicle 300.

### [With Respect to Billing Management]

FIG. 10 is a flowchart showing an example of the billing management. The billing management part 430 executes the following flow for each electrically driven vehicle 300. The discount amount deriving part 432 determines whether the electric power amount is added to the discount amount (step S201). When the electric power amount is added to the discount amount, the discount amount deriving part 432 derives a first addition parameter according to a total discharge electric power amount or a total charge electric power amount (step S203). The total discharge electric power amount is a total value of the electric power amount discharged during storage, and the total charge electric power amount is a total value of the electric power amount charged during storage.

Next, the discount amount deriving part 432 determines whether the time length is added to the discount amount (step S205). When the time length is added to the discount amount, the discount amount deriving part 432 derives a second addition parameter according to a time length such as the storage period, the total discharge period, the total charge period, and the like (step S207). The total discharge period is a total value of the time length in the discharge during storage, and the total charge time length is a total value of the time length in the charge during storage.

Next, the discount amount deriving part 432 determines whether the cooperation level is added to the discount amount (step S209). When the cooperation level is added to the discount, the discount amount deriving part 432 derives a third addition parameter according to the cooperation level (step S211). The third addition parameter is increased when the cooperation level is high than when the cooperation level is low.

The discount amount deriving part 432 derives the discount amount on the basis of the derived addition parameter (step S213). The billing part 433 subtracts the discount amount from the expected sales price, and derives the billing price (step S215).

As described above, in the storage method of a secondary battery that will be mounted or that is mounted on an electrically driven vehicle at before of a delivery to a user, during a storage at before of a delivery to the user, the supply and demand adjustment of the electric power system is performed using the secondary battery, payment is charged to the user by discounting the extent of the decrease in performance of the secondary battery caused by the supply and demand adjustment from the price of the electrically driven vehicle, and thus, the electrically driven vehicle 300 or the in-vehicle battery 310 at before of a delivery to the user can be stored in consideration of efficiency of the in-vehicle battery 310.

As a result, it is possible generate a value and reflect the value to the billing price by using the in-vehicle battery that is to be sold (an electric motor car and manufacturing and repairing the electric motor car) during storage. In addition, sleeping battery assets are expensive to store even during they are only being stored, and the asset values are also decreased. By making effective use of them, it is possible to create new value, to provide the electrically driven vehicle at a lower price than before, and to contribute to the adjustment of the electric power demand and supply balance in the world.

The above-mentioned embodiment can be expressed as follows.

A storage method of a secondary battery comprising a storage device in which a program is stored; and

a hardware processor,

the storage method comprising:

executing the program stored in the storage device using the hardware processor;

performing a supply and demand adjustment of an electric power system by using the secondary battery that will be mounted or that is mounted on an electrically driven vehicle during a storage of the second battery at before of the delivery to a user; and

billing the user a payment by discounting an extent of a decrease in performance of the secondary battery caused by the supply and demand adjustment from a price of the electrically driven vehicle.

Hereinabove, while preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims. Further, some components of the supply and demand adjustment part 420 may be mounted on the external power supply device 200 or may be mounted on the electrically driven vehicle 300.

What is claimed is:

1. A storage method of a secondary battery that will be mounted or that is mounted on an electrically driven vehicle at before of a delivery to a user, the storage method comprising:
performing a supply and demand adjustment of an electric power system by using the secondary battery during a storage of the secondary battery at before of the delivery to the user; and
billing the user a payment by discounting an extent of a decrease in performance of the secondary battery caused by the supply and demand adjustment from a price of the electrically driven vehicle.

2. The storage method of the secondary battery according to claim 1, wherein, when the supply and demand adjustment is performed, the supply and demand adjustment using the secondary battery is performed within a range in which an extent of a decrease in performance of the secondary battery caused by the supply and demand adjustment falls in a range allowed by the user.

3. The storage method of the secondary battery according to claim 2, wherein, when the supply and demand adjustment is performed, the range in which the extent of the decrease in performance of the secondary battery caused by the supply and demand adjustment falls in the range allowed by the user is determined on the basis of a charging amount of the electrically driven vehicle.

4. The storage method of the secondary battery according to claim 1, wherein the discount from the price is derived on the basis of a use aspect of the secondary battery during the storage.

5. A storage system of a secondary battery that will be mounted or that is mounted on an electrically driven vehicle at before of a delivery to a user, the storage system comprising:
a supply and demand adjustment part configured to perform a supply and demand adjustment of an electric power system by using the secondary battery during a storage of the secondary battery at before of the delivery to the user; and
a billing management part configured to bill the user a payment by discounting an extent of a decrease in performance of the secondary battery caused by the supply and demand adjustment from a price of the electrically driven vehicle.

6. A computer-readable recording medium, in which a program is stored to cause a computer to
perform a supply and demand adjustment of an electric power system by using a secondary battery that will be mounted or that is mounted on an electrically driven vehicle during a storage of the secondary battery at before of the delivery to a user; and
bill the user a payment by discounting an extent of a decrease in performance of the secondary battery caused by the supply and demand adjustment from a price of the electrically driven vehicle.
